(19) United States
(12) Patent Application Publication
(10) Pub. No.: US 2026/0167008 A1
(43) Pub. Date: Jun. 18, 2026

(54) REGENERATIVE BRAKING OVERLAY DURING FRICTION BRAKING AND METHOD

(71) Applicant: International Truck Intellectual Property Company, LLC, Lisle, IL (US)

(72) Inventors: Dhaval Bhikhubhai Lodaya, Farmington Hills, MI (US); Grant Goodwin Davisson, St. Charles, IL (US)

(73) Assignee: International Truck Intellectual Property Company, LLC, Lisle, IL (US)

(21) Appl. No.: 18/985,964

(22) Filed: Dec. 18, 2024

(51) Int. Cl. B60L 7/10

(52) U.S. Cl. CPC B60L 7/10; B60L 2250/28

(57) ABSTRACT

A regenerative braking overlay during friction braking is provided for operating regenerative braking during friction braking. The regenerative braking overlay during friction braking may include electric vehicle components, battery control unit, sensors, friction braking, and regenerative braking. A method for overlaying regenerative braking during friction braking using the regenerative braking overlay during friction braking is also provided.

### FIELD OF THE INVENTION

The present disclosure relates to a regenerative braking overlay during friction braking. More particularly, the disclosure relates to overlaying regenerative braking during friction braking.

### BACKGROUND

Regenerative braking is a key technology in electric vehicles (EVs) that captures the kinetic energy generated during deceleration and converts it back into electrical energy, which is then used to recharge the vehicle's battery. Unlike conventional friction braking systems that dissipate this energy as heat, regenerative braking recovers kinetic energy to improve vehicle energy efficiency and extend its driving range. This is particularly crucial for electric trucks, which carry heavy loads and operate in demanding conditions, requiring them to maximize energy utilization.

However, the current driver controls for regenerative braking in electric trucks present a significant obstacle to its optimal utilization. The typical settings (Off, L1, L2, L3) activate regenerative braking whenever the driver releases the accelerator pedal. This “always-on” approach can feel unnatural to drivers accustomed to coasting in traditional vehicles, causing a sense of reduced control and unnatural driving experience.

This disconnect between driver expectations and the regenerative braking system often results in drivers completely disabling the feature or using it only when absolutely necessary. This behavior negates the benefits of regenerative braking, leading to increased reliance on friction brakes, which waste energy and generate heat. This not only reduces the truck's efficiency but also increases wear and tear on the braking components, leading to higher maintenance costs.

Therefore, a need exists to solve the deficiencies present in the prior art. What is needed is a system to enable regenerative braking to overlay friction braking while still allowing an operator to coast when releasing the accelerator. What is needed is a system to provide regenerative braking to supplement friction braking that is substantially transparent to an operator.

### SUMMARY

An aspect of the disclosure advantageously provides a system to overlay regenerative braking. An aspect of the disclosure advantageously provides a system to enable regenerative braking to overlay friction braking while still allowing an operator to coast when releasing the accelerator. An aspect of the disclosure advantageously provides a system to provide regenerative braking to supplement friction braking that is substantially transparent to an operator.

Accordingly, the disclosure may feature a system for overlaying regenerative braking during friction braking for a vehicle comprising a battery control unit, a sensor (e.g., drive-by-wire sensor, without limitation), and/or other components. In an embodiment, a drive-by-wire sensor and/or other sensor may determine an accelerator pedal position and a brake pedal position. While operating in the regenerative braking overlay mode, if the accelerator pedal position and the brake pedal position are at rest, the vehicle may revert to standard regenerative braking. If the brake pedal position is at least partially depressed, a requested braking force may be determined, and the regenerative braking may be operated to apply at least part of the requested braking force as defined by a regenerative braking condition. The friction braking may be selectively operated to supplement the regenerative braking such to fulfill the requested braking force.

In another aspect, the regenerative braking condition may include a graduated regenerative braking application. If the brake pedal position is at least partially depressed for at least a first brake pedal duration, the regenerative braking condition may operate the regenerative braking at a first regenerative braking level. If the brake pedal position is at least partially depressed for at least a second brake pedal duration, the regenerative braking condition may operate the regenerative braking at a second regenerative braking level.

In another aspect, the graduated regenerative braking application may further include, if the brake pedal position is at least partially depressed for at least a third brake pedal duration, operating the regenerative braking at a third regenerative braking level.

In another aspect, after operating the regenerative braking, and if the brake pedal position is returned to being at rest, a reset timer may begin, and the regenerative braking may continue operating until the reset timer expires.

In another aspect, the regenerative braking condition may include a constant regenerative braking application, which may calibrate the regenerative braking to a calibrated regenerative braking level respective to the vehicle and, if the brake pedal position is at least partially depressed, operate the regenerative braking at the calibrated regenerative braking level.

In another aspect, the regenerative braking condition may include a variable regenerative braking application, which may determine a vehicle mass estimation for the vehicle, calibrate the regenerative braking to a calibrated regenerative braking level respective to the vehicle mass estimation and, if the brake pedal position is at least partially depressed, operate the regenerative braking to the calibrated regenerative braking level.

In another aspect, the brake pedal position may include a first brake pedal position and a second brake pedal position. The regenerative braking condition may include a dynamic regenerative braking application that performs the steps of mapping a minimum dynamic regenerative braking level to the first brake pedal position and mapping a maximum dynamic regenerative braking level to the second brake pedal position. If the brake pedal position exceeds the first brake pedal position, the regenerative braking may be operated at a dynamic regenerative braking level at or between the minimum dynamic regenerative braking level and the maximum regenerative braking level respective to the brake pedal position.

In another aspect, the dynamic regenerative braking application may further determine the brake pedal position relative to the first brake pedal position and the second brake pedal position as a dynamic brake pedal position. The dynamic regenerative braking level may be interpolated between the minimum dynamic regenerative braking level and the maximum regenerative braking level to correspond with the dynamic brake pedal position relative to the first brake pedal position and the second brake pedal position. For the brake pedal position that exceeds the second brake pedal position, the regenerative braking may be operated at the maximum dynamic regenerative braking level.

In another aspect, a battery management module may be included to determine a state of charge of a battery operatively charged via the regenerative braking and limiting operation of the regenerative braking if the state of charge indicates a capacity of the battery would be exceeded.

According to an embodiment of this disclosure, a method is provided for overlaying regenerative braking during friction braking for a vehicle. Operating in the regenerative braking overlay mode may include determining an accelerator pedal position and a brake pedal position, if the accelerator pedal position and the brake pedal position are at rest, reverting to standard regenerative braking. Operating in the regenerative braking overlay mode may also include, if the brake pedal position is at least partially depressed, determining a requested braking force and operating the regenerative braking to apply at least part of the requested braking force as defined by a regenerative braking condition. Operating in the regenerative braking overlay mode may further include selectively operating the friction braking to supplement the regenerative braking such to fulfill the requested braking force.

In another aspect of the method, the regenerative braking condition may include a graduated regenerative braking application. In this aspect, if the brake pedal position is at least partially depressed for at least a first brake pedal duration, the regenerative braking may be operated at a first regenerative braking level. If the brake pedal position is at least partially depressed for at least a second brake pedal duration, the regenerative braking may be operated at a second regenerative braking level.

In another aspect of the method, the regenerative braking condition may include a constant regenerative braking application. In this aspect, the method may include calibrating the regenerative braking to a calibrated regenerative braking level respective to the vehicle and, if the brake pedal position is at least partially depressed, operating the regenerative braking at the calibrated regenerative braking level.

In another aspect of the method, the regenerative braking condition may include a variable regenerative braking application. In this aspect, the method may include determining a vehicle mass estimation for the vehicle, calibrating the regenerative braking to a calibrated regenerative braking level respective to the vehicle mass estimation and, if the brake pedal position is at least partially depressed, operating the regenerative braking to the calibrated regenerative braking level.

In another aspect of the method, the brake pedal position may include a first brake pedal position and a second brake pedal position. Wherein the regenerative braking condition includes a dynamic regenerative braking application, the method may further include mapping a minimum dynamic regenerative braking level to the first brake pedal position, mapping a maximum dynamic regenerative braking level to the second brake pedal position, and determining the brake pedal position relative to the first brake pedal position and the second brake pedal position as a dynamic brake pedal position. The method may further include interpolating a dynamic regenerative braking level between the minimum dynamic regenerative braking level and the maximum regenerative braking level to correspond with the dynamic brake pedal position relative to the first brake pedal position and the second brake pedal position and for the brake pedal position that exceeds the second brake pedal position, operating the regenerative braking at the maximum dynamic regenerative braking level.

According to an embodiment of this disclosure, a system is provided for overlaying regenerative braking during friction braking for a vehicle. The system may include a sensor, such as a drive-by-wire sensor for example, to determine an accelerator pedal position and a brake pedal position while operating in a regenerative braking overlay mode. If the accelerator pedal position and the brake pedal position are at rest, standard regenerative braking will take effect. If the brake pedal position is at least partially depressed, a requested braking force may be determined, and the regenerative braking may be operated to apply at least part of the requested braking force as defined by a regenerative braking condition comprising a graduated regenerative braking application. If the brake pedal position is at least partially depressed for at least a first brake pedal duration, the regenerative braking may be operated at a first regenerative braking level. If the brake pedal position is at least partially depressed for at least a second brake pedal duration, the regenerative braking may be operated at a second regenerative braking level. If the brake pedal position is at least partially depressed for at least a third brake pedal duration, the regenerative braking may be operated at a third regenerative braking level. After operating the regenerative braking, and if the brake pedal position is returned to being at rest, a reset timer may begin, and the existing regenerative braking level (e.g., L₁, L₂, L₃, etc.) may continue to be enabled until the reset timer expires. The friction braking may be selectively operated to supplement the regenerative braking such to fulfill the requested braking force.

Terms and expressions used throughout this disclosure are to be interpreted broadly. Terms are intended to be understood respective to the definitions provided by this specification. Technical dictionaries and common meanings understood within the applicable art are intended to supplement these definitions. In instances where no suitable definition can be determined from the specification or technical dictionaries, such terms should be understood according to their plain and common meaning. However, any definitions provided by the specification will govern above all other sources.

Various objects, features, aspects, and advantages described by this disclosure will become more apparent from the following detailed description, along with the accompanying drawings in which like numerals represent like components.

### BRIEF DESCRIPTION OF THE DRAWINGS

FIG. 1 is a block diagram view of an illustrative system for overlaying regenerative braking during friction braking, according to an embodiment of this disclosure.

FIG. 2 is a flow chart view of an illustrative operation for enabling a regenerative braking overlay mode, according to an embodiment of this disclosure.

FIG. 3 is a flow chart view of an illustrative operation for providing regenerative braking overlay during friction braking via graduated regenerative braking, according to an embodiment of this disclosure.

FIG. 4 is a graph view of the illustrative operation of FIG. 3 for providing regenerative braking overlay during friction braking via graduated regenerative braking, according to an embodiment of this disclosure.

FIG. 5 is a flow chart view of an illustrative operation for providing regenerative braking overlay during friction braking via constant regenerative braking, according to an embodiment of this disclosure.

FIG. 6 is a graph view of the illustrative operation of FIG. 5 for providing regenerative braking overlay during friction braking via constant regenerative braking, according to an embodiment of this disclosure.

FIG. 7 is a flow chart view of an illustrative operation for providing regenerative braking overlay during friction braking via variable regenerative braking, according to an embodiment of this disclosure.

FIG. 8 is a graph view of the illustrative operation of FIG. 7 for providing regenerative braking overlay during friction braking via variable regenerative braking, according to an embodiment of this disclosure.

FIG. 9 is a flow chart view of an illustrative operation for providing regenerative braking overlay during friction braking via dynamic regenerative braking, according to an embodiment of this disclosure.

FIG. 10 is a graph view of the illustrative operation of FIG. 9 for providing regenerative braking overlay during friction braking via dynamic regenerative braking, according to an embodiment of this disclosure.

### DETAILED DESCRIPTION

The following disclosure is provided to describe various embodiments of a regenerative braking overlay during friction braking. Skilled artisans will appreciate additional embodiments and uses of the present invention that extend beyond the examples of this disclosure. Terms included by any claim are to be interpreted as defined within this disclosure. Singular forms should be read to contemplate and disclose plural alternatives. Similarly, plural forms should be read to contemplate and disclose singular alternatives. Conjunctions should be read as inclusive except where stated otherwise.

Expressions such as “at least one of A, B, and C” should be read to permit any of A, B, or C singularly or in combination with the remaining elements. Additionally, such groups may include multiple instances of one or more element in that group, which may be included with other elements of the group. All numbers, measurements, and values are given as approximations unless expressly stated otherwise.

For the purpose of clearly describing the components and features discussed throughout this disclosure, some frequently used terms will now be defined, without limitation. The term regenerative braking, as it is used throughout this disclosure, is defined as a system in electric and hybrid vehicles that captures kinetic energy during deceleration and converts it into electricity to recharge the battery. The term friction braking, as it is used throughout this disclosure, is defined as a system that uses friction between two surfaces to convert kinetic energy into heat, slowing or stopping a vehicle. The term regenerative operational state, as it is used throughout this disclosure, is defined as a selected operational mode for an electric vehicle to enable and disable regenerative braking and determine the level of regenerative braking applied when enabled. The term normal operation of regenerative braking operational state, as it is used throughout this disclosure, is defined as applying regenerative braking when the accelerator pedal is at a state of rest and/or power output is not demanded of the vehicle.

The term requested braking force, as it is used throughout this disclosure, is defined as a requested stopping power for a vehicle, typically determined by brake pedal position and/or brake application pressure. The term reset timer, as it is used throughout this disclosure, is defined as duration of time that must elapse before an regenerative braking overlay mode may be disengaged, which may be set by an operator and/or adjusted dynamicaly. The term vehicle mass estimation, as it is used throughout this disclosure, is defined as the process of determining the approximate weight of a vehicle, including passengers and cargo, such as by using sensors and algorithms.

Various aspects of the present disclosure will now be described in detail, without limitation. In the following disclosure, a regenerative braking overlay during friction braking will be discussed. Those of skill in the art will appreciate alternative labeling of the regenerative braking overlay during friction braking as a friction braking assistance system using regenerative braking, the invention, or other similar names. Similarly, those of skill in the art will appreciate alternative labeling of the regenerative braking overlay during friction braking as a method for overlaying regenerative braking during friction braking, method for enabling friction braking while regenerative braking remains enabled,, the invention, or other similar names. Skilled readers should not view the inclusion of any alternative labels as limiting in any way.

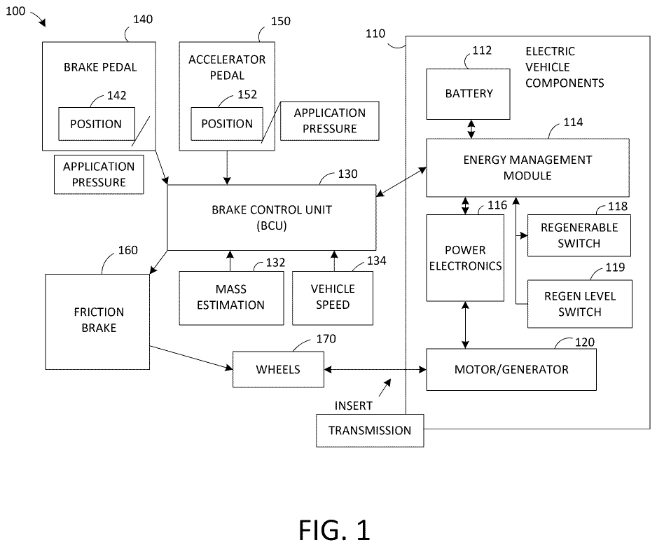

Referring now to FIGS. 1-10, the regenerative braking overlay during friction braking will now be discussed in more detail. The regenerative braking overlay during friction braking may include electric vehicle components, battery control unit, sensors, friction braking, regenerative braking, and additional components that will be discussed in greater detail below. The regenerative braking overlay during friction braking may operate one or more of these components interactively with other components for overlaying regenerative braking during friction braking.

Various embodiments included throughout this disclosure enable an innovative and advantageous approach mitigates disabling of regenerative braking systems due to driver preferences, while continuing to benefit from regenerative braking being essentially transparent to the operator. By practicing the embodiments enabled by this disclosure, vehicles can advantageously operate with increased energy efficiency, ensuring that valuable kinetic energy is recovered during braking without compromising the driver's desired vehicle behavior.

According to the various embodiments enabled by this disclosure, a regenerative braking overlay is provided to provide the benefits of regenerative braking when a driver applies the service brake pedal, indicating their intention to decelerate the vehicle. A system enabled by this disclosure may intelligently recognize the braking event and engage regeneration to supplement the traditional friction brakes.

This regenerative braking overlay functionality is achieved through a combination of inputs and logic, through which a system enabled by this disclosure may monitor the brake pedal switch to detect when the brake pedal is depressed, signaling the driver's intent to slow down. Additionally, brake pedal application pressure, position, or duration may also be monitored to determine the intensity of the braking demand. By allowing the vehicle to coast freely when the accelerator pedal is released, the system satisfies the driver's desire for a familiar driving experience without having to forego the benefits of regenerative braking when the driver wishes to slow the vehicle, such as by engaging the service brake.

According to various embodiments enabled throughout this disclosure, regenerative braking overlay systems may be substantially seamlessly integrated into existing vehicle architectures. The use of readily available inputs, such as brake pedal position and regen brake switches, allows for easy implementation without requiring significant modifications to the vehicle's braking system. Moreover, solutions enabled by this disclosure can be further refined to provide a more personalized braking experience. The override functionality can be customized based on individual driver preferences, allowing for adjustments to the intensity and responsiveness of regenerative braking during override events.

The electric vehicle components that may be used with various embodiments enabled by this disclosure will now be discussed in greater detail. FIG. 1 highlights examples of the electric vehicle components, which may also be shown in other figures. The electric vehicle components 110 may include a battery 112 and energy management module 114. The energy management module 114 may be communicably connected to power electronics 116, a regenerative braking enable switch 118, and regenerative braking level switch 119. The power electronics 116 may communicate instructions from the energy management module 114 to the motor/generator 120, which may be used to provide traction power to the vehicle's wheels 170 and/or provide regenerative braking from the vehicle wheels 170. Power generated by the motor/generator 120 via regenerative braking may be supplied to the battery 112, for example, via the energy management module 110.

The energy management module 114 may monitor the battery 112 for a state of charge, temperature, and overall health to ensure optimal charging conditions. The energy management module 114 may regulate the flow of electricity from the motor/generator 120 to the battery 112, for example via the power electronics 116, preventing overcharging and maximizing battery lifespan. Normal operation of regenerative braking may be controlled by the energy management module 114, which may receive inputs from the regenerative braking enable switch 118 to enable/disable operation, the regenerative braking level switch 119 to select between various levels of regenerative braking, and other inputs that would be appreciated by those of skill in the art. Illustrative regenerative braking levels that may be selected via the regenerative braking level switch 119 may include L1, L2, L3, each of which may have increasingly aggressive regeneration profiles, and/or other regenerative braking levels that would be apparent to skilled artisans after having the benefit of this disclosure.

The brake control unit 130 in a regenerative braking system enabled by this disclosure may act as the central coordinator, intelligently balancing operation between regenerative and friction braking 160. The brake unit controller 130 may receive information from various sensors, including pedal position and/or application pressure 142 of a brake pedal 140 and accelerator pedal position and/or application pressure 152 of an accelerator pedal 150, vehicle mass estimation 132, vehicle speed 134, wheel torque, and/or other sensors that would be appreciated by those of skill in the art to determine the driver's requested braking force. Based on this information, such as provided by the various sensors, the brake control unit 130 may precisely allocate braking effort between regenerative braking, which captures energy, and the traditional friction brakes 160, ensuring smooth and effective deceleration while maximizing energy recovery.

In operation, a method may be provided for overlaying regenerative braking during friction braking. Those of skill in the art will appreciate that the following methods are provided to illustrate an embodiment of the disclosure and should not be viewed as limiting the disclosure to only those methods or aspects. Skilled artisans will appreciate additional methods within the scope and spirit of the disclosure for performing the operations provided by the examples below after having the benefit of this disclosure. Such additional methods are intended to be included by this disclosure.

A system enabled by this disclosure may advantageously optimize regenerative braking in vehicles. By intelligently integrating regenerative braking with traditional friction braking 160, systems and methods enabled by this disclosure may increase energy recovery without compromising the driver's desired vehicle behavior. When a regenerative operation state is set to on, regenerative braking may operate normally, for example, providing regenerative braking as a selected level when an accelerator pedal 150 is at rest and the brake pedal is not being depressed. In some embodiments, this normal operation may occur when the brake pedal 140 is active or at rest. While operating in the regenerative braking overlay mode, regenerative braking may be operated upon the driver at least partially applying the brake pedal 140.

In one embodiment, one or more sensors, such as, without limitation drive-by-wire sensors, may monitor the accelerator pedal 150 and/or brake pedal 140, for example, to determine an accelerator pedal position and/or application pressure 152 and/or brake pedal position and/or application pressure 142. A battery control unit 130 may determine the appropriate braking strategy based on pedal inputs and the chosen regenerative operational state. For example, when the system is in the overlay mode and the driver presses the brake pedal 140, the system may calculate the requested braking force representative of a driver's desired deceleration rate. The system may then intelligently distribute this braking force between the regenerative braking system via the motor/generator 120 and the traditional friction brakes 160. As will be appreciated by those of skill in the art, the friction brakes 160 may be selectively applied to supplement the motor/generator 120 used in regenerative braking, ensuring that the total braking force matches the driver's request.

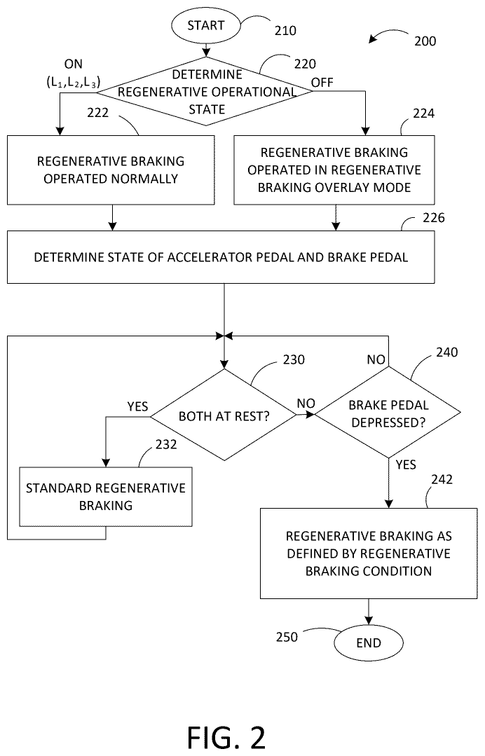

Referring now to flowchart 200 of FIG. 2, an example method for an illustrative operation for enabling a regenerative braking overlay mode will be described, without limitation. Starting with Block 210, the operation may begin by determining which regenerative operation state the driver has selected (e.g., L1, L2, L3, etc.). (Block 220). It is then determined at Block 224 whether regenerative braking is set to operate in a regenerative braking overlay mode.

After the operation of Block 222 or Block 224, it may then be determined the state of the accelerator pedal and the brake pedal. For example, it may be determined if both the accelerator pedal and the brake pedal are at rest at Block 230. If it is determined at Block 230 that both the accelerator pedal and the brake pedal are at rest, the vehicle may operate in standard regenerative braking mode with regenerative braking enabled at a level selected by the driver. (Block 232). During this mode, the vehicle may continue to determine whether the accelerator pedal and brake pedal remain at rest, as discussed for the operation of Block 230.

If it is determined at Block 230 that the accelerator pedal and the brake pedal are not both at rest, it may then be determined at Block 240 if the brake pedal is depressed. If it is determined at Block 240 that the brake pedal has not been depressed, the operator may return to Block 230 where it will additionally be determined whether the accelerator pedal has been depressed. If it is determined at Block 240 that the brake pedal has been depressed, regenerative braking may be operated as defined by a regenerative braking condition. (Block 242). Examples of regenerative braking conditions will be discussed in greater detail below, without limitation. The operation may then end at Block 250.

An illustrative regenerative braking condition including a graduated regenerative braking application will now be discussed, without limitation. According to an embodiment of this disclosure, a graduated application of regenerative braking based on the duration of brake pedal depression may be used to provide an intuitive and responsive braking feel, further optimizing energy recovery and driver satisfaction. In this embodiment, a position of the brake pedal may be monitored to determine whether it has been depressed and with a duration for which the brake pedal has been depressed. This temporal-based, graduated approach advantageously allows the system to tailor the level of regenerative braking to the driver's braking requirement.

For example, when the brake pedal is initially depressed for at least a first brake pedal duration, the system may engage regenerative braking at a first regenerative braking level, for example, L1. This initial level provides a gentle incorporation of regenerative braking. As the driver continues to depress the brake pedal for at least a second brake pedal duration, the system may increase the amount of regenerative braking applied to a second regenerative braking level, for example L2, which may operate stronger regenerative braking.

Furthermore, the system can be further refined by incorporating additional levels of regenerative braking. For instance, in some embodiments, a third regenerative braking level can be operated upon the brake pedal being depressed for at least a third brake pedal duration, from which the regenerative braking may operate at a third regenerative braking level, for example, L3. In some embodiments, a reset timer may be started upon engaging the graduated regenerative braking application that, once started, will be required to expire after the brake pedal is returned to being at rest after regenerative braking has occurred. As examples, provided without limitation, a conservative schedule may be used where L1 is about 1 second, L2 is about 2 seconds, L3 is about 3 seconds, and the reset timer is about 1 second; an aggressive schedule may be use where L1 is about 0.5 seconds, L2 is about 1 second, L3 is about 1.5 seconds, and the reset timer is about 1 second; and/or another schedule that would be apparent to a person of skill in the art after having the benefit of this disclosure.

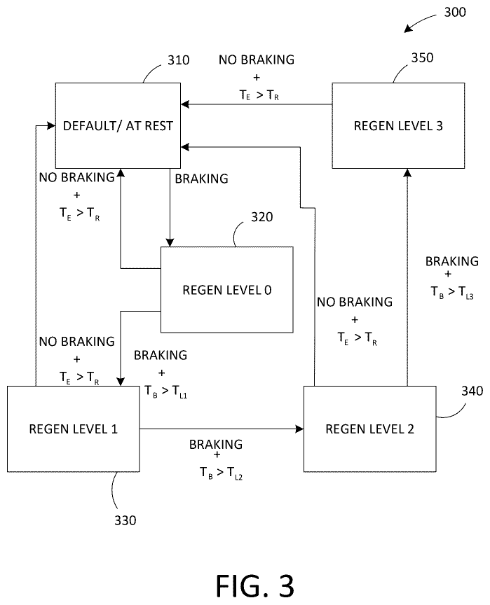

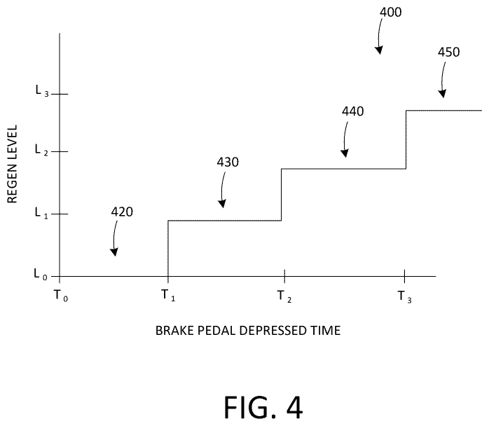

Referring now to flowchart 300 of FIG. 3, viewed along with graph 400 of FIG. 4, an example method for a providing regenerative braking overlay during friction braking via graduated regenerative braking will be described, without limitation. Starting with Block 310, the operation may begin by the regenerative braking being at a state of rest, which may be a default state. If it is determined from Block 310 that the brake pedal is at least partially depressed, the regenerative braking may be elevated to a regenerative braking level zero (Block 320). As seen at event 420 of graph 400, minimal if any regenerative braking may occur at regenerative braking level zero. Since a braking event was detected, a reset timer may begin and/or be restarted until the brake pedal is no longer depressed. Alternatively, it may be determined if a braking event is occurring by monitoring the pressure applied to the brake.

If it is determined from Block 320 that the braking event is no longer occurring, and if it is determined that the time elapsed since the brake pedal was returned to rest (T_{E}) is longer than the reset timer (T_{R}), the operation may return to the default state at Block 310 and revert to an operational state of regenerative braking disabled. If it is determined at Block 320 that the braking event, for example a time that the brake pedal is depressed (T_{B}), continues for at least the first brake pedal duration (T_{L1}), the operation may proceed to a first regenerative braking level as indicated by Block 330. As seen at event 430 of graph 400, regenerative braking may occur at a first regenerative braking level. Since a braking event was detected, a reset timer may begin and/or be restarted until the brake pedal is no longer depressed.

If it is determined from Block 330 that the braking event is no longer occurring, and if it is determined that the time elapsed since the brake pedal was returned to rest (T_{E}) is longer than the reset timer (T_{R}), the operation may return to the default state at Block 310. If it is determined at Block 330 that the braking event, for example a time that the brake pedal is depressed (T_{B}), continues for at least the second brake pedal duration (T_{L2}), the operation may proceed to a second regenerative braking level as indicated by Block 340. As seen at event 440 of graph 400, regenerative braking may occur at a second regenerative braking level. Since a braking event was detected, a reset timer may begin and/or be restarted until the brake pedal is no longer depressed.

If it is determined from Block 340 that the braking event is no longer occurring, and if it is determined that the time elapsed since the brake pedal was returned to rest (T_{E}) is longer than the reset timer (T_{R}), the operation may return to the default state at Block 310. If it is determined at Block 340 that the braking event, for example a time that the brake pedal is depressed (T_{B}), continues for at least the third brake pedal duration (T_{L3}), the operation may proceed to a third regenerative braking level as indicated by Block 350. As seen at event 450 of graph 400, regenerative braking may occur at a third regenerative braking level. Since a braking event was detected, a reset timer may begin and/or be restarted until the brake pedal is no longer depressed. Regenerative braking may continue at the third regenerative braking level until it is determined that that the time elapsed since the brake pedal was returned to rest (T_{E}) is longer than the reset timer (T_{R}), after which the operation may return to the default state at Block 310.

An illustrative regenerative braking condition including a constant regenerative braking application will now be discussed, without limitation. According to an embodiment of this disclosure, a constant level of regeneration application may be applied for at a calibrated regenerative braking level determined through a calibration process that takes into account the characteristics of the vehicle, such as its weight, motor properties, battery capacity, and other conditions that would be appreciated by a person of skill in the art after having the benefit of this disclosure. This constant level of regenerative braking advantageously simplifies the braking experience for the driver, providing a consistent and predictable response.

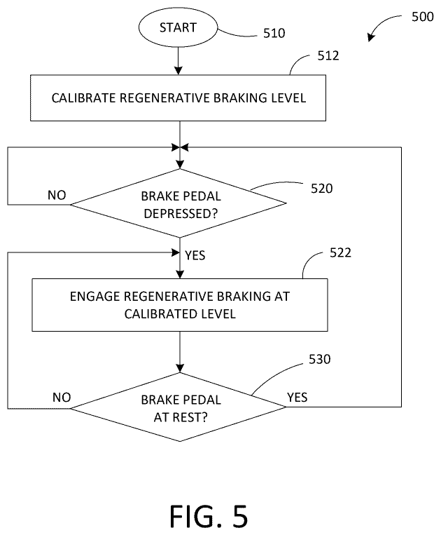

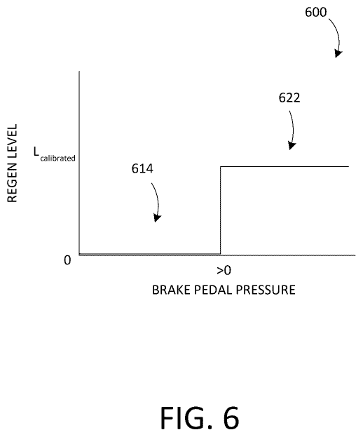

Referring now to flowchart 500 of FIG. 5, viewed along with graph 600 of FIG. 6, an example method for a providing regenerative braking overlay during friction braking via constant regenerative braking will be described, without limitation. Starting with Block 510, the operation may begin by calibrating a regenerative braking level for a vehicle. (Block 512). It may then be determined at Block 520 if the brake pedal is depressed. If it is determined at Block 520 that the brake pedal remains at rest, the operation may continue to monitor the brake pedal for activity without engaging overlay regenerative braking. This nonengagement of regenerative braking is indicated by level 614 of graph 600. If it is determined at Block 520 that the brake pedal is at least partially depressed, the regenerative braking may operate at the calibrated level (Block 522), as represented by level 622 of graph 600.

After operation of Block 522, it may then be determined if the brake pedal is now at rest. (Block 530). If it is determined at Block 530 that the brake pedal is not at rest, and thus is at least partially depressed, the operation will continue at Block 522 to operate regenerative braking. If it is determined at Block 530 that the brake pedal is now at rest, the operation will return to monitoring whether the brake pedal is again depressed at Block 520.

An illustrative regenerative braking condition including a variable regenerative braking application will now be discussed, without limitation. According to an embodiment of this disclosure, a variable regenerative braking application may estimate the vehicle mass. As will be appreciated by those of skill in the art, vehicle mass estimation may be achieved through a combination of sensors and algorithms that monitor various parameters, such as suspension deflection, acceleration, and wheel speed. By analyzing these data points, the system can accurately estimate the total weight of the vehicle, including passengers and cargo. This vehicle mass estimation may then be used to calibrate the regenerative braking system based on the estimated vehicle mass.

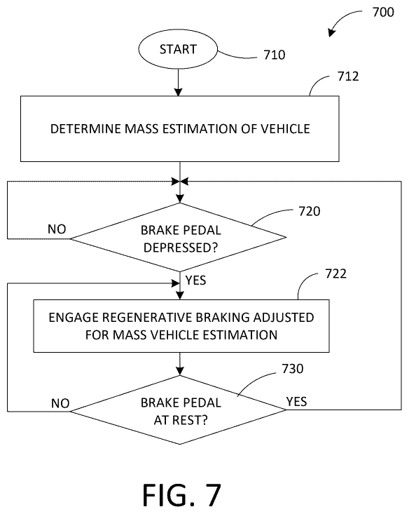

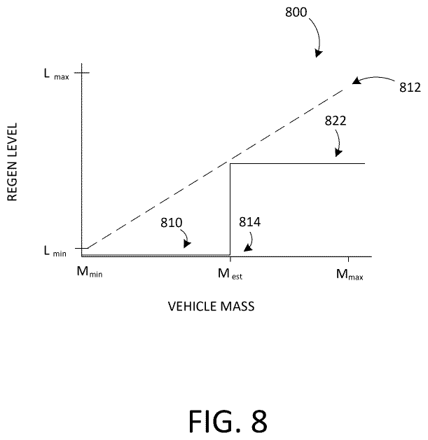

Referring now to flowchart 700 of FIG. 7, viewed along with graph 800 of FIG. 8, an example method for a providing regenerative braking overlay during friction braking via variable regenerative braking will be described, without limitation. Starting with Block 710, the operation may begin by determining a mass estimation of the vehicle. (Block 712). Once determined, the vehicle mass estimation (Mₑₛₜ) may be correlated at a point 814 about a vehicle mass estimation curve 812 to determine an adjusted level of regenerative braking to be used for the estimated vehicle mass.

It may then be determined at Block 720 if the brake pedal is depressed. If it is determined at Block 720 that the brake pedal remains at rest, the operation may continue to monitor the brake pedal for activity without engaging overlay regenerative braking. This nonengagement of regenerative braking is indicated by level 810 of graph 800. If it is determined at Block 720 that the brake pedal is at least partially depressed, the regenerative braking may operate as adjusted for the mass vehicle estimation (Block 722), as represented by level 822 of graph 800.

After operation of Block 722, it may then be determined if the brake pedal is now at rest. (Block 730). If it is determined at Block 730 that the brake pedal is not at rest, and thus is at least partially depressed, the operation will continue at Block 722 to operate regenerative braking. If it is determined at Block 730 that the brake pedal is now at rest, the operation will return to monitoring whether the brake pedal is again depressed at Block 720.

An illustrative regenerative braking condition including a dynamic regenerative braking application will now be discussed, without limitation. According to an embodiment of this disclosure, a dynamic regenerative braking application may be provided by adjusting the intensity of regenerative braking in proportion to the brake pedal position. This dynamic approach advantageously offers a seamless and intuitive braking experience, maximizing energy recovery while providing a natural and responsive feel for the driver.

Using dynamic regenerative braking application as the regenerative braking condition, a relationship between brake pedal position and regenerative braking intensity is established by providing a first brake pedal position, a second brake pedal position, and intermediate brake pedal positions between the first and second brake pedal positions that may correlate with a maximum regenerative braking level. These positions may represent distinct levels of brake pedal depression, corresponding to different braking demands.

Brake pedal position may be associated with corresponding regenerative braking levels. For example, a first brake pedal position may be mapped to a minimum dynamic regenerative braking level, representing the initial engagement of regenerative braking. As the driver presses the brake pedal beyond this initial position, the regenerative braking force may increase proportionally. The second brake pedal position may be mapped to a maximum dynamic regenerative braking level, which may provide a peak intensity of regenerative braking to capture the maximum amount of kinetic energy. Between the first brake pedal position and the second brake pedal position, the pedal position may be interpolated to determine a regenerative braking level based on the position of the brake pedal, creating a continuous and dynamic relationship between pedal position and regenerative braking force. Those skilled in the art will readily appreciate analogous embodiments based upon brake pressure application.

In some embodiments, as the driver presses the brake pedal beyond the second brake pedal position, the system may maintain the maximum dynamic regenerative braking level throughout the rest of the range of travel of the brake pedal. Engaging the maximum dynamic regenerative braking level prior to the full length of travel of the brake pedal advantageously provides consistently high regenerative braking force even under heavy braking demands, maximizing energy recovery without causing abrupt changes in deceleration.

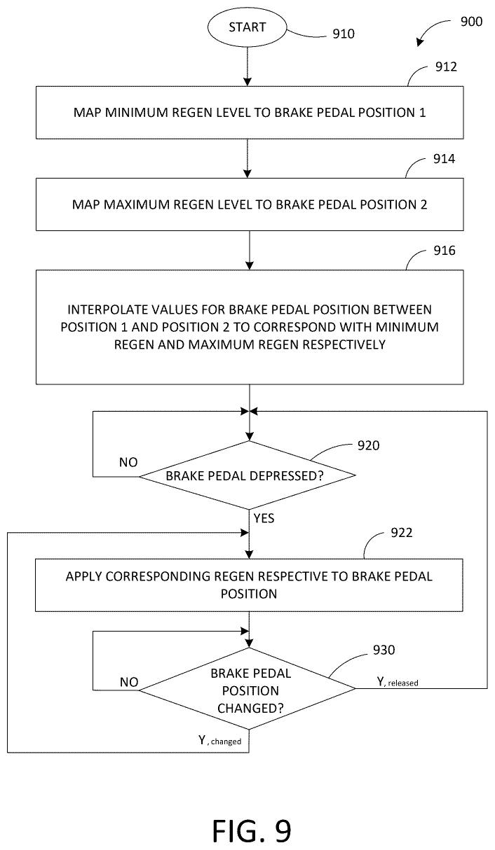

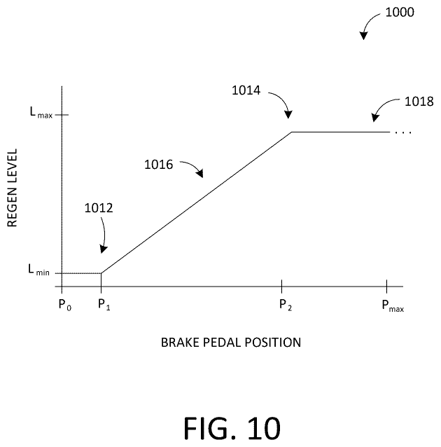

Referring now to flowchart 900 of FIG. 9, viewed along with graph 1000 of FIG. 10, an example method for a providing regenerative braking overlay during friction braking via dynamic regenerative braking will be described, without limitation. Starting with Block 910, the operation may begin by mapping a minimum dynamic regenerative braking level to a first brake pedal position (Block 912), which corresponds to position 1012 of graph 1000. A maximum dynamic regenerative braking level may then be mapped to a first brake pedal position (Block 914), which corresponds with position 1014 of graph 1000. Values between the first brake pedal position and the second brake pedal position may be interpolated to correspond with the minimum dynamic regenerative braking level and the maximum dynamic regenerative braking level (Block 916), which corresponds with interpolated range 1016 of graph 1000. Depressing the brake pedal beyond the second brake pedal position may maintain operation of regenerative braking at the maximum dynamic regenerative braking level, as indicated by range 1018 of graph 1000.

It may then be determined at Block 920 if the brake pedal is depressed. If it is determined at Block 920 that the brake pedal remains at rest, the operation may continue to monitor the brake pedal for activity without engaging overlay regenerative braking. If it is determined at Block 920 that the brake pedal is at least partially depressed, the regenerative braking may operate corresponding with the actual or interpolated brake pedal position as discussed above (Block 922), as represented by levels 1012, 1014, 1016, and 1018 of graph 1000.

After operation of Block 922, it may then be determined if the brake pedal position has changed. (Block 930). If it is determined at Block 930 that the brake pedal position has not changed, the operation may continue to monitor the brake pedal for a change in position at Block 930. If it is determined at Block 930 that brake pedal position has changed, but is not at rest, and thus is at least partially depressed, the operation will continue at Block 922 to operate regenerative braking. If it is determined at Block 930 that the brake pedal position has changed and is now at rest, the operation will return to monitoring whether the brake pedal is again depressed at Block 920.

In an alternative embodiment enabled by this disclosure, a battery configured to receive the electrical charge produced by the regenerative braking may be monitored for a state of charge. The system of this embodiment may monitor that regenerative braking operates within safe limits, preventing overcharging and maximizing the lifespan of the battery. For example, the battery management module may monitor the state of charge of the battery and communicate with the regenerative braking system to make informed decisions about when and how much energy to recover. If the state of charge indicates that the battery is approaching its maximum capacity, the battery management module may signal the regenerative braking system to limit its operation and rely on friction braking to fulfill the requested braking force. For example, charging rate of the regenerative braking may be gradually reduced as the battery approaches full capacity. Alternatively, regenerative braking may be temporarily disabled until some capacity to receive additional charge increases.

While various aspects have been described in the above disclosure, the description of this disclosure is intended to illustrate and not limit the scope of the invention. The invention is defined by the scope of the appended claims and not the illustrations and examples provided in the above disclosure. Skilled artisans will appreciate additional aspects of the invention, which may be realized in alternative embodiments, after having the benefit of the above disclosure. Other aspects, advantages, embodiments, and modifications are within the scope of the following claims.

What is claimed is:

1. A system for overlaying regenerative braking during friction braking for a vehicle comprising:
a battery control unit to determine a regenerative operational state; and
a sensor to determine an accelerator pedal position and a brake pedal position, wherein while operating in a regenerative braking overlay mode, if the brake pedal position is at least partially depressed, determining a requested braking force and operating regenerative braking to apply at least part of the requested braking force as defined by a regenerative braking condition;
wherein the friction braking is selectively operated to supplement the regenerative braking such to fulfill the requested braking force.

2. The system of claim 1, wherein the regenerative braking condition comprises a graduated regenerative braking application comprising the steps:
if the brake pedal position is at least partially depressed for at least a first brake pedal duration, operating the regenerative braking at a first regenerative braking level; and
if the brake pedal position is at least partially depressed for at least a second brake pedal duration, operating the regenerative braking at a second regenerative braking level.

3. The system of claim 2, wherein the graduated regenerative braking application further comprises the step:
if the brake pedal position is at least partially depressed for at least a third brake pedal duration, operating the regenerative braking at a third regenerative braking level.

4. The system of claim 2, wherein after operating the regenerative braking, and if the brake pedal position is returned to being at rest, a reset timer begins; and
wherein the existing regenerative braking operational state remains enabled until the reset timer expires.

5. The system of claim 1, comprising the steps:
calibrating the regenerative braking to a calibrated regenerative braking level respective to the vehicle; and
if the brake pedal position is at least partially depressed, operating the regenerative braking at the calibrated regenerative braking level.

6. The system of claim 1, wherein the regenerative braking condition comprises a variable regenerative braking application comprising the steps:
determining a vehicle mass estimation for the vehicle;
calibrating the regenerative braking to a calibrated regenerative braking level respective to the vehicle mass estimation; and
if the brake pedal position is at least partially depressed, operating the regenerative braking to the calibrated regenerative braking level.

7. The system of claim 1:
wherein the brake pedal position comprises a first brake pedal position and a second brake pedal position;
wherein the regenerative braking condition comprises a dynamic regenerative braking application comprising the steps:
mapping a minimum dynamic regenerative braking level to the first brake pedal position, and
mapping a maximum dynamic regenerative braking level to the second brake pedal position; and
if the brake pedal position exceeds the first brake pedal position, operating the regenerative braking to a dynamic regenerative braking level at or between the minimum dynamic regenerative braking level and the maximum regenerative braking level respective to the brake pedal position.

8. The system of claim 7, wherein the dynamic regenerative braking application further comprises the steps:
determining the brake pedal position relative to the first brake pedal position and the second brake pedal position as a dynamic brake pedal position;
interpolating the dynamic regenerative braking level between the minimum dynamic regenerative braking level and the maximum regenerative braking level to correspond with the dynamic brake pedal position relative to the first brake pedal position and the second brake pedal position; and
for the brake pedal position that exceeds the second brake pedal position, operating the regenerative braking at the maximum dynamic regenerative braking level.

9. The system of claim 1, further comprising a battery management module to determine a state of charge of a battery operatively charged via the regenerative braking and limiting operation of the regenerative braking if the state of charge indicates a capacity of the battery would be exceeded.

10. A method of overlaying regenerative braking during friction braking for a vehicle comprising:
determining a regenerative operational state;
determining an accelerator pedal position and a brake pedal position, wherein if the brake pedal position is at least partially depressed, determining a requested braking force and operating the regenerative braking to apply at least part of the requested braking force as defined by a regenerative braking condition; and
selectively operating the friction braking to supplement the regenerative braking such to fulfill the requested braking force.

11. The method of claim 10, wherein the regenerative braking condition comprises a graduated regenerative braking application operated by performing the steps comprising:
if the brake pedal position is at least partially depressed for at least a first brake pedal duration, operating the regenerative braking at a first regenerative braking level;
if the brake pedal position is at least partially depressed for at least a second brake pedal duration, operating the regenerative braking at a second regenerative braking level;
wherein after operating the regenerative braking, and if the brake pedal position is returned to being at rest, beginning a reset timer; and
operating the regenerative braking until the reset timer expires.

12. The method of claim 10, wherein the regenerative braking condition comprises a regenerative braking application operated by performing the steps comprising:
calibrating the regenerative braking to a calibrated regenerative braking level respective to the vehicle; and
if the brake pedal position is at least partially depressed, operating the regenerative braking at the calibrated regenerative braking level.

13. The method of claim 10, wherein the regenerative braking condition comprises a variable regenerative braking application operated by performing the steps comprising:
determining a vehicle mass estimation for the vehicle;
calibrating the regenerative braking to a calibrated regenerative braking level respective to the vehicle mass estimation; and
if the brake pedal position is at least partially depressed, operating the regenerative braking to the calibrated regenerative braking level.

14. The method of claim 10:
wherein the brake pedal position comprises a first brake pedal position and a second brake pedal position;
wherein the regenerative braking condition comprises a dynamic regenerative braking application operated by performing the steps comprising:
mapping a minimum dynamic regenerative braking level to the first brake pedal position,
mapping a maximum dynamic regenerative braking level to the second brake pedal position,
determining the brake pedal position relative to the first brake pedal position and the second brake pedal position as a dynamic brake pedal position,
interpolating a dynamic regenerative braking level between the minimum dynamic regenerative braking level and the maximum regenerative braking level to correspond with the dynamic brake pedal position relative to the first brake pedal position and the second brake pedal position, and
for the brake pedal position that exceeds the second brake pedal position, operating the regenerative braking at the maximum dynamic regenerative braking level.

15. A system for overlaying regenerative braking during friction braking for a vehicle comprising:
a sensor to determine an accelerator pedal position and a brake pedal position while operating in a regenerative braking overlay mode;
wherein if the brake pedal position is at least partially depressed, a requested braking force is determined and the regenerative braking is operated to apply at least part of the requested braking force as defined by a regenerative braking condition comprising a graduated regenerative braking application operated by performing the steps comprising:
if the brake pedal position is at least partially depressed for at least a first brake pedal duration, operating the regenerative braking at a first regenerative braking level,
if the brake pedal position is at least partially depressed for at least a second brake pedal duration, operating the regenerative braking at a second regenerative braking level,
if the brake pedal position is at least partially depressed for at least a third brake pedal duration, operating the regenerative braking at a third regenerative braking level, and
after operating the regenerative braking, and if the brake pedal position is returned to being at rest, a reset timer begins and the regenerative braking remains enabled until the reset timer expires; and
wherein the friction braking is selectively operated to supplement the regenerative braking such to fulfill the requested braking force.
